(19) United States
(12) Patent Application Publication
(10) Pub. No.: US 2009/0221765 A1
(43) Pub. Date: Sep. 3, 2009

(54) POLYMER FOR USE IN A TUNEABLE DIFFRACTION GRATING (TDG) MODULATOR

(75) Inventors: Lars Henriksen, Tonsberg (NO); Vladimir Kartashov, Horten (NO)

Correspondence Address: KNOBBE MARTENS OLSON & BEAR LLP, 2040 MAIN STREET, FOURTEENTH FLOOR, IRVINE, CA, 92614, US

(73) Assignee: Polight AS, Horten (NO)

(21) Appl. No.: 12/096,583

(22) PCT Filed: Dec. 6, 2006
(86) PCT No.: PCT/NO06/00463

§ 371 Date: Oct. 20, 2008

(30) Foreign Application Priority Data
Dec. 6, 2005 (NO) 20055781

(51) Int. Cl. C08F 283/12

(52) U.S. Cl. 525/479; 525/474

(57) ABSTRACT

The present invention relates to a tuneable diffraction grating modulator based on the principle of total internal reflection comprising an elastomer as a deformable layer to be modulated in a nonuniform electric field.

### BACKGROUND OF THE INVENTION

This invention relates to the field of Tuneable Diffraction Grating (TDG) optical chips based on the principle of total internal reflection (TIR) as exemplified by U.S. Pat. No. 6,897,995.

Examples of application areas for the TDG chip are telecom (optical communications) (Fig A) and display (FIG. 2). Both markets represent an increasing demand for price-competitive technologies that allow for mass production with high yield, thereby offering new products and services to the end-users.

The working principle for the TDG is the surface modulation of a gel film by electrical fields imposed by electrodes on a substrate. Details of the function of the TDG modulator are described in for example U.S. Pat. No. 6,897,995 (detailed in FIG. 3). The gel can be any macromolecular network with an appropriate swelling agent. Even gelatin gels have been reported to function, but with obvious limitations in temperature range and life time. The by far most promising gel system has been silicone gels, more accurately polydimethyl siloxane gels, examples of this are given in WO 01/48531.

The TDG modulators, which this invention relates to, are based on total internal reflection of incoming light in an interface polymer gel/air. This construction is fundamentally different from other, well known light modulators, based on a deformable polymer sandwiched between two electrode sets. There are two fundamental differences; one is that light does not pass through the polymer film, the other is that the physics responsible for the deformation are different.

A light modulator based on total internal reflection has the advantages of having 100% optical efficiency, in contrast to metallic reflection, that typically is 80-90%. In applications with high optical flux, the fraction of non-reflected light will lead to heat generation and will give additional demands to the construction of the modulator. In many applications (for example telecom and display), the optical efficiency of an actuating device will be a crucial parameter that contributes to the overall quality of the device.

From a physical point of view, light modulators based on total internal reflection, can be described with the same set of equations as light modulators that are built up of a deformable material (a polymer) between two electrode sets, as exemplified by Uma et al. (in IEEE J. Sel. Topics in Quantum Elec., 10 (3), 2004), Gerhard-Mülthaupt (in Displays, Technol. Applicat., 12, 115-128, 1991) etc.

The basic differences between the two types are a) TIR modulators have two dissimilar materials (air and polymer), b) the polymer/gel film in a TIR modulator must be transparent and c) forces in reflective modulators origin from discrete electrical charges, while in TIR modulators, dipole orientation has an effect.

In practice, these differences mean that the polymer film in reflective modulators may be of any kind that is deformable (including for example non-transparent materials), while for TIR-modulators, the significance of transparency and dipole dislocations is evident. To a person skilled in the art, it is therefore obvious that there are completely different requirements to the polymer film in light modulators based on the TIR principle than in reflective modulators.

The dynamic response, given by the time to reach say 90% of the desired relief amplitude, and the sensitivity of the TDG/TIR modulator, given by the relief amplitude per applied volt, are both critical parameters for the operation of the modulator. These parameters are controlled by adjusting the composition of the gel and geometric parameters, such as gel thickness and gap between gel and electrodes. What time constant is required will depend on the application the TDG modulator is intended for.

Upon closer examination of the dynamic response of the silicone gels to voltage pulses, it has become evident that there exists a slow response in the seconds range. For applications that require a dynamic response quicker than this, this response will obviously cause unwanted effects.

### OBJECTS OF THE INVENTION

The main object of the invention is to provide a polymer film based on cross-linked polymers where the above described response in the seconds-range is eliminated.

It is, therefore, another object of this invention to provide ways of improving the performance of TDG modulators based on total internal reflection (TIR) in applications that require full relief amplitude in a time shorter than the observed response in the seconds-range.

### BRIEF SUMMARY OF THE INVENTION

The use of macromolecular gels in TDG modulators based on total internal reflection (TIR) is described well in for example U.S. Pat. No. 6,897,995. The principle of operation is the formation of an nonuniform electrical field that creates a force on the surface of the polymer gel film. The main principle of operation of a polymer gel based TDG modulator is described stepwise below (See FIG. 3 for a schematic description):
The macromolecular gel is located as a thin film on the surface of a prism
The gel surface is assembled at a fixed given distance from an electrode substrate
The electrodes are patterned, giving parallel electrodes that are connected alternately
A bias voltage is set up between the gel/prism interface and the electrode substrate
Signal voltage is applied to every second electrode (or positive to one and negative to the next)
An nonuniform electrical field is thus formed, which creates a force on the deformable gel film
The gel film is deformed according to the electrical field, giving a spatial surface modulation determined by the electrode pattern and the voltages imposed on the device.
The modulation imposed on the surface scatters incoming light as required by the end application. When the surface is not modulated, the incoming light experiences total internal reflection in the interface between the gel and the gas gap.

In principle, there should be only two mechanisms that will influence the dynamic response of the TDG modulator—the viscoelastic response of the macromolecular gel, and the dislocation of charges that may be present on the gel film surface. Both these processes are relatively quick, and will have time constants far shorter than 1 second.

We have observed that there exists another mechanism with a time constant in the range of 1 second to 100 seconds, or more, depending on parameters such as the viscosity of the swelling agent/plasticizer in the gel. This effect will lead to an additional contribution to the relief amplitude in this time scale. Many applications for TDG modulators (both telecom, as exemplified by U.S. Pat. No. 6,897,995, and display) are operated with requirements of full response well within 1 second. It is therefore not surprising that the said observations may cause unwanted effects during operation of the TDG modulators.

Quite surprisingly, we observed that when we actively reduced the amount of swelling agent in the gel, the slow response in the seconds-range was gradually eliminated. One example of this behavior is shown in FIG. 4.

This invention therefore relates to modifying the composition of the polymer film, by leaving out the unlinked swelling agent in the polymer, reducing the gel to an elastomer. Another part of the invention is the active control of the presence of other, unlinked components that in some cases could be present in the final, cured polymer film. This will include both unreactive contaminants in the pre-polymer chemicals and by-products from secondary reactions that with some conditions will take place concurrently with the network forming reactions.

### BRIEF DESCRIPTION OF DRAWINGS

FIG. 1 shows an embodiment of the Tuneable Diffraction Grating (TDG) optical chip as known from prior art (U.S. Pat. No. 6,897,995), i) overview, ii) details in upper left corner.

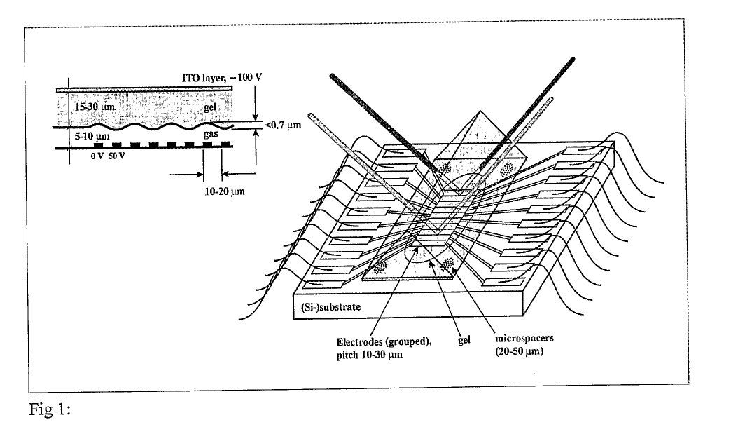

FIG. 2 shows an embodiment of a projector system where the Tuneable Diffraction Grating (TDG) optical chip is a part.

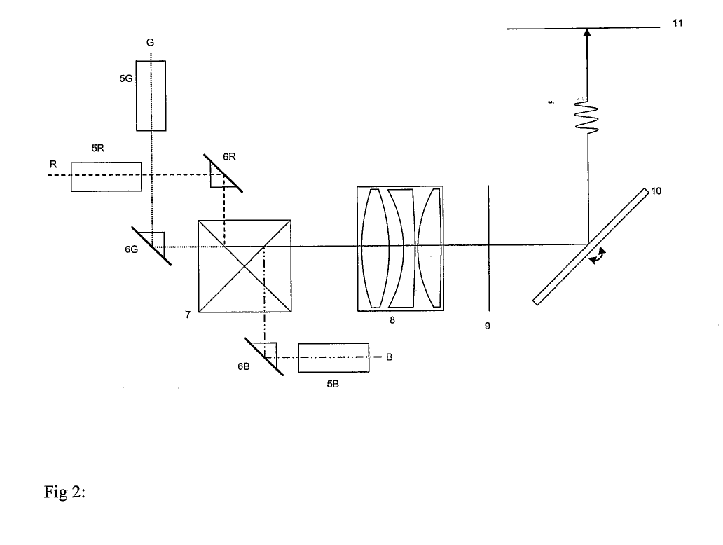

FIG. 3 shows a section of an embodiment of a light modulator as exemplified in U.S. Pat. No. 6,897,995. Electrode direction perpendicular to paper plane. Assumtions: V1 unequal to V2 and V bias unequal to V substrate.

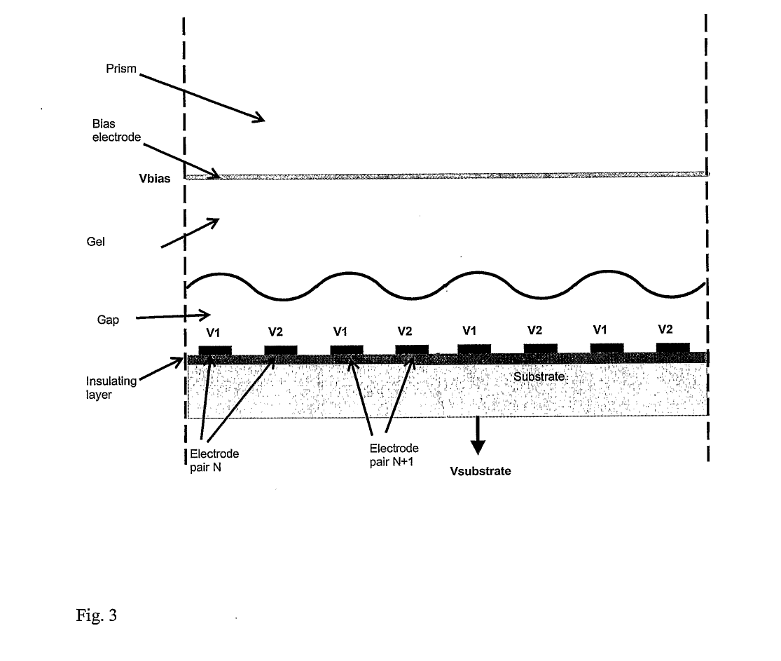

FIG. 4 shows optical damping as a function of time based on the Example.

### DETAILED DESCRIPTION OF THE INVENTION

Traditionally, in TDG modulators based on the TIR principle, a macromolecular gel is employed as the deformable material that is to be modulated in the nonuniform electrical field. This gel is commonly a polydimethyl siloxane gel, a crosslinked network of polydimethylsiloxane swelled with a linear polydimethyl siloxane oil, although other gel systems have been reported (see WO 01/48531 and references herein for examples). To the best of the inventors knowledge elastomers have not earlier been used in TDG modulators based on the TIR principle. There is a fundamental difference between gels and elastomers, in that a gel conceptually speaking is a liquid held together by a polymer network, while elastomers are condensed, non-flowing matter.

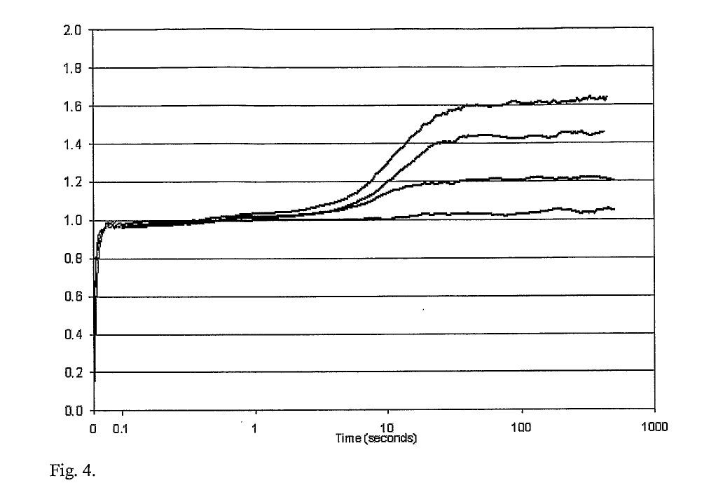

When the swelling agent is excluded from the polymer, and an elastomer thus is formed, we have seen that a less complex dynamic behavior is observed when signal voltages are applied in the modulator. In one embodiment, with a slow characteristic response in the seconds range, the slow response is totally eliminated when the swelling agent is gradually removed from the polymer, see FIG. 4. The feature of this part of the invention is the composition of the polymer that gives this improved behavior in TDG modulators.

The inventors believe, that in contrast to reflective light modulators, which have an electrically conducting and optically reflective coating/top electrode, dislocations of dipoles are significant in the physical description of the relief formation. This dipole dislocation, that occur due to the presence of the non-uniform and dynamic electrical field at and near the interface between the gel film and the air, we believe, cause the liquid oil present in the gel to travel, a process similar to molecular diffusion.

Firstly, according to the present invention, use may be made of all polymer systems that can form a cross-linked network and remain flexible within the temperature range the TDG modulator shall be operated in, without the use of swelling agents, plasticizers or other unlinked modifiers that are mobile in the polymer network system. The elastomers shall have a storage modulus (G′) in the range 0.5 to 1000 kPa, or more preferably between 1 to 300 kPa. The storage modulus is a measure of the elastic component of the sample, also called dynamic rigidity, and is the real component of the modulus in an oscillatory rheology measurement.

More specifically, according to the present invention use may be made of polyorganosiloxane elastomers created for example by

A) addition reactions between linear or branched silicone polymers or oligomers with vinyl groups attached, or mixtures thereof, and a hydride containing cross-linker, using a transition metal catalyst, such as for example nobel metal complexes or other compounds thereof, such as Pt complexes, chloroplatinic acid, etc. (hydrosilylation). An appropriate ratio between vinyl and hydride must be employed, in order to obtain a cross-linked polymer system that will not flow.

B) condensation reactions between linear or branched silicone polymers or oligomers with hydroxy groups attached, or mixtures thereof, and an alkoxy containing cross-linker, using for example Sn catalysts. An appropriate ratio between hydroxyl and alkoxy must be employed, in order to obtain a cross-linked polymer system that will not flow.

C) reactions between other functionalized organosiloxanes with proper cross-linkers, examples of embodiments are
1. epoxy-functionalized organosiloxanes with amine, etc. cross-linkers
2. silanol/hydride dehydrogenative coupling, using metal salts
3. ionomeric crosslinking
4. vinyl/peroxide cure
5. radical/peroxide cure of acrylate/methacrylate siloxanes
6. mercapto/thiolene UV or thermal cure
7. acetoxy/chlorine/dimethylamine, moisture cure

Elastomers made up of polydimethyl siloxanes and/or copolymers of dimethyl-, methylphenyl- and diphenyl siloxanes prepared according to known cross-linking reactions, such as for example hydrosilylation, Sn-catalyzed alkoxy/hydroxy reactions, etc. may be used according to the present invention.

Another part of the invention is the application of known purifying techniques for the removal of non-reactive substances in the pre-polymers used to make the cross-linked polymer films.

Yet another part of the invention is the active control of by-products during the curing reactions, in order to reduce the amount of unlinked components in the polymer film to below a critical value that will no longer cause unwanted effects in the operation of the TDG modulator.

The example below is intended as an illustration of the present invention and is not to be construed as a limitation of the scope the invention.

### EXAMPLE

A study was carried out wherein the amount of swelling agent in a polydimethyl siloxane gel was reduced in a stepwise manner. The polymer films studied contained 70%, 50%, 20% and 0% polydimethylsiloxane swelling agent, a linear polydimethyl siloxane with viscosity 10 cSt. All chemicals were used as delivered from the producer, without purification.

The results are presented in FIG. 4 showing optical damping, which is related to relief amplitude, as a function of time. The values are normalized in order to show the relative effect at times >1 second. The curves represent, from top to bottom, polymers with 70, 50, 20 and 0% swelling agent.

1. A tuneable diffraction grating (TDG) modulator with total internal reflection (TIR), comprising, as a deformable layer to be modulated in a nonuniform electric field, an elastomer having a storage modulus in the range of 0.5 to 1000 kPa.

2. The tuneable diffraction grating (TDG) modulator according to claim 1, wherein the elastomer has a storage modulus in the range of 1 to 300 kPa.

3. The tuneable diffraction grating (TDG) modulator according to claim 1, wherein said elastomer is a polyorganosiloxane elastomer.

4. A method for the preparation of an elastomer for use in a tuneable diffraction grating (TDG) modulator, comprising reacting linear or branched silicone polymers or oligomers with pendant groups, or mixtures thereof, with a cross linker using a catalyst.

5. The method of claim 4, wherein the reaction is an addition reaction.

6. The method of claim 5, wherein the pendant groups are vinyl groups.

7. The method according to any one of claim 5, wherein the cross linker is a hydride containing cross linker.

8. The method according to claim 5, wherein the catalyst is a transition metal catalyst.

9. The method according to claim 5, wherein the catalyst is selected from the group comprising nobel metal complexes and other compounds thereof.

10. The method of claim 4, wherein the reaction is a condensation reaction.

11. The method according to claim 10, wherein the pendant groups are hydroxyl groups.

12. The method according to claim 10, wherein the cross linker is an alkoxy containing cross linker.

13. The method according to claim 10, wherein the catalyst is selected from Sn-catalysts.

14. The method according to claim 4, wherein purifying techniques are employed for the removal of non-reactive substances in prepolymers used to make the elastomer in the form of a cross linked polymer film.

15. The method according to claim 4, wherein by-products during curing reactions are controlled in order to reduce the amount of unlinked components in the elastomer which is formed as a polymer film.

16. Use of an elastomer having a storage modulus in the range of 0.5 to 1000 kPa as a deformable layer in a tuneable diffraction grating modulator.

17. Use according to claim 16, wherein the elastomer has a storage modulus of 1 to 300 kPa.
